(19) United States
(12) Patent Application Publication
(10) Pub. No.: US 2008/0235141 A1
(43) Pub. Date: Sep. 25, 2008

(54) License manager and schema

(75) Inventors: Israel Hilerio, Redmond, WA (US); Eric B. Watson, Redmond, WA (US); Lingan Satkunanathan, Kirkland, WA (US); Bjorn B. Levidow, Bellevue, WA (US); Nisheeth Srivastava, Redmond, WA (US); Krishna Sunkammurali, Sammamish, WA (US); Bruce A. Johnson, Woodinville, WA (US); Murali Vajjiravel, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/726,070

(22) Filed: Mar. 21, 2007

(51) Int. Cl. H04L 9/00

(52) U.S. Cl. 705/59

(57) ABSTRACT

A license management system may have an adapter or interface that enables any type of licensed software or service to be managed through a common administrative view. The adapters may use a common schema that includes various parameters about a license as well as information that may enable a license management system to interact with a license vendor or license provider. The licenses may include locally operating software, software operating over a local area network, and various services that may be provided over a network including the Internet. The license management system may support many types of licenses and may be able to consolidate license management of many different devices and types of devices. The license management system may display the various licenses, as well as provide some other functions including alerting, usage monitoring, and managing licenses.

### BACKGROUND

There are many different types of licenses for computer-related applications, software, and services. Perpetual licenses may be purchased for stand alone applications, operating systems, or other software that operates on a local device. Shared licenses may be issued for applications that are delivered over a network or are used through different devices on the network. Some services may be offered on a per-use license and operate on a local device or delivered through the Internet from a remote server. Still other licenses may be time limited, such as a subscription that may be periodically renewed.

Various devices may operate licensed software or may access licensed services. Personal computers, servers, game consoles, network appliances, hand held devices, wireless devices, or any other type of device capable of executing software or providing access to a licensed service may have licensed software or services.

### SUMMARY

A license management system may have an adapter or interface that enables any type of licensed software or service to be managed through a common administrative view. The adapters may use a common schema that includes various parameters about a license as well as information that may enable a license management system to interact with a license vendor or license provider. The licenses may include locally operating software, software operating over a local area network, and various services that may be provided over a network including the Internet. The license management system may support many types of licenses and may be able to consolidate license management of many different devices and types of devices. The license management system may display the various licenses, as well as provide some other functions including alerting, usage monitoring, and managing licenses.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a license system.

FIG. 2 is a diagram of an embodiment showing a license management system.

FIG. 3 is a flowchart illustration of an embodiment showing a method for collecting and storing license information.

FIG. 4 is a diagram of an embodiment showing a schema for license information.

### DETAILED DESCRIPTION

A license manager has an interface through which many disparate licenses may be managed. The interface may enable licenses from different software manufacturers and with different license types to interface with the license manager and be viewed and managed from a single interface. The licenses may be for applications operating on a local device, applications delivered over a local area network, services provided through the Internet over various mechanisms, or any other license or subscription for hardware, software, or a service.

The interface may accommodate subscription services as well as perpetual licenses. The licenses may include interfaces to license repositories that are shared by several users on a local area network, and may also include a pool of licenses that are periodically used on one device for a period of time and released for another user.

The interface may enable services that are provided through the Internet to be managed through the license manager. A license provider or service provider may send data through the interface to allow the license manager to manage the license. The data may include web addresses or other connection information so that a user may interact with the service provider either directly or through the license manager. The user may interact with the service provider to change the terms of the licenses, renew licenses, return licenses, or various other tasks.

The license manager may consolidate the licenses for multiple devices and multiple users. In many cases, a license manager may oversee licenses for a group of devices or users, such as in a home network, a small business, or a large enterprise.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

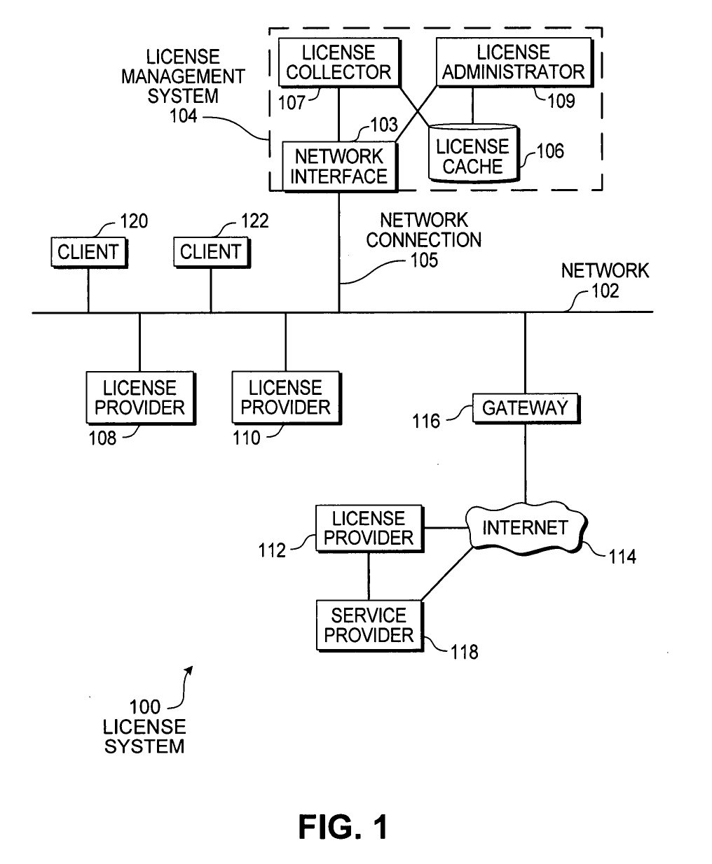

FIG. 1 is a diagram of an embodiment 100 showing a license management system. Connected to the network 102 is a license manager 104 may provide various management functions for different licenses across the system, such as viewing a consolidated list of disparate licenses, monitoring license usage, communicating with various license providers 108, 110, and 112, as well as any other function that may be envisioned.

The license management system 104 has a network interface 103 connected to a network connection 105 to network 102. A license collector 107 may receive license information and store the license information in a license cache 106. A license administrator 109 may perform various management functions on the licenses.

The license providers 108 and 110 may be directly connected to the network 102 and may communicate with the license manager 104 through the network 102. License provider 112 may communicate with the network 102 through the Internet 114 and a gateway 116. The license provider 112 may be a license provider for a service provider 118 that is accessed through the Internet 114.

Client devices 120 and 122 are connected to the network 102 any may use software applications or services that are local to the client device or provided over the network 102 or through the Internet 114.

Software applications or services may be licensed as a mechanism for selling software or services. In a typical example, a software application may be licensed to operate on a device on a perpetual basis. Once the software application is installed on the device, the license may not permit the software to be installed on another device.

Other software licensing schemes may involve a group of licenses that may be shared across several devices. For example, some computer aided design applications and other expensive applications may have a central server that allocates a license for various devices on a network each time a session is started for the application. When the session is terminated, the license may be released to the license server so that another device may use the application.

In some situations, licenses may permit a specific device to operate an application or service, while in other situations, licenses may be given for specific users. For example, an email server application may have a license for operating on a server device even though many users may access the server application. In another example, a customer resource management (CRM) system may be licensed as a separate license for each individual user even though the CRM application operates on a single server device.

Some services and applications may be licensed on a per use manner, where each use of a particular function is monitored and purchased. Other licenses may require a periodic renewal and may have a time-bomb feature that disables the license after a period of time.

Groups of licenses may be purchased and distributed at a later date. For example, a software application or service may be purchased in blocks of a certain number of licenses. A user may purchase 50 licenses but only install or use 35 licenses initially, leaving 15 licenses purchased but unused. Over time, the user may allocate the remaining licenses by assigning the licenses to new devices or users.

Some license agreements may have a provision for a user to return or disable a license. In some cases, such a license may be disabled and returned for a credit or for a new license that may be transferred to another device or user.

Many different types of devices may operate licensed software applications or services. Personal computers typically operate several different software packages that may be licensed, such as an operating system and various software applications. It is not uncommon for a personal computer to have a dozen or more licensed software products and may connect to several licensed services that are provided through services over a local area network (LAN), wide area network (WAN), or the Internet. Licenses may be used for end user software applications such as word processors, spreadsheets, and other end user applications. Licenses may also be used for various software components that are used by applications or integrated with other software components.

Other computer devices, such as various types of servers, may have several licensed software applications or components. Server devices may operate software applications or components that have complex licensing schemes, such as licenses that may be shared across connected devices or accessed by different users. Some server devices may have services or applications that are licensed on a per-use basis.

Various services or access to software products may be provided through the Internet. For example, an email server may be located on and accessed via the Internet. In another example, a customer resource management system may be provided through a web-based service. Such services may or may not have a software component installed on a client device through which the service is accessed. In some cases, a thin client, access software, a cookie, or other software component may be installed on a client device designated to access the service. In other cases, a general purpose browser may be used to access the service without an installed component on a client device.

In both the case of an installed software application and a service provided via another device, a user may be given a license to specific software functionality. The functionality may be a subset of all the functionality available with the application or service.

When specific functionality is licensed, a user may or may not have access to physical media on which the software commands may be stored. In either case, licenses may be managed in a single license manager 104. In some instances, a user may not know or be concerned with where the actual software is being executed.

A license may include access to or possession of computer data, as well as executable code or functional services. In some instances, one license may cover data while another license may cover a functional software system to access or manipulate the data. For example, a license may enable a user to have access to a database of recorded music or video while another license may enable a software application to manipulate the data on a client device.

Many other devices may execute licensed software or may be used to access various services. Personal digital assistants (PDA), cellular telephones, media players, network appliances, game consoles, or any other device that may execute software or access data may have one or more licensed software application, component, or service.

The license manager 104 may be a stand alone device or an application or component operable on a device attached to the network 102. In some embodiments, the license manager 104 may be operating on one device, such as a server device, but may be access through a remote interface on a client device. In many embodiments, a single device may operate as a license manager 104, client 120, and license provider 108, while in other embodiments, the components may be operable on two or more individual devices.

The license providers 108, 110, and 112 may be any type of device or system that provides license information. In many cases, a license provider may interact with a software application to permit or deny execution or access to the software application. In other cases, a license provider may have a central repository from which licenses used by several devices or users may be assigned. In such a case, the licenses may include keywords, serial numbers, or some other unique identifier that may be transmitted to an assigned device and may be used to access the licensed product using the device.

A license provider 108 or 110 may be an application or component operable on a device on the network 102. Such an application may broadcast a message over the network 102 to locate the license manager 104 and transmit license information to the license manager 104. In other instances, the license provider may be an application that responds to requests from the license manager 104. In still other instances, the license provider may be a data file that the license manager 104 may locate and retrieve.

License provider 112 is located on the Internet 114 and may be used to provide license services for the service provider 118 also located on the Internet 114. In some instances, the Internet-based license provider 112 may provide licenses for applications operable on local clients 120 and 122. Similarly, the local license providers 108 and 110 may provide licenses for services provided through the Internet-based service provider 118.

The license cache 106 may store various data about licenses. In some instances, the license cache 106 may contain data on multiple devices attached to the network 102 while in other instances, the license cache 106 may contain data on licenses for the device to which it is attached. The license cache 106 may be updated by various license providers 108, 110, and 112 when a change occurs with a license. In some instances, the license manager 104 may periodically collect data from each of the license providers while in other instances, the license providers may push data to the license manager 104 when a change occurs.

The license cache 106 may be any type of data storage device accessible to the license manager 104. In some embodiments, the license cache 106 may be connected to the license manager 104 through a network connection or through an Internet connection.

The license administrator 109 may perform many different tasks associated with licenses. For example, the license administrator 109 may allow a user to view the licenses in the license cache 106. Other administrative functions may also be performed, including generating and sending alerts when various conditions exist, updating or renewing licenses, assigning or allocating licenses to various devices or users, monitoring usage of licensed services or products, or any other function.

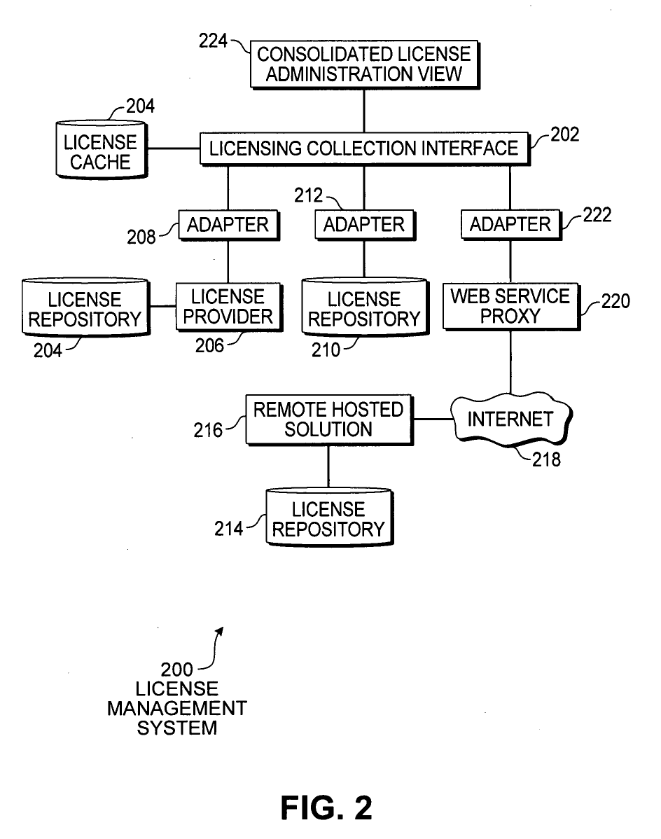

FIG. 2 is a diagram illustration of an embodiment 200 showing software components that make up a license management system. The licensing collection interface 202 may be a common interface through which license information may be collected and stored in a license cache 104. The license repository 204 is accessed through a license provider 206 and an adapter 208 to the licensing collection interface 202. The license repository 210 is accessed directly through the adapter 212, while the license repository 214 is accessed through a remote hosted solution 216, the Internet 218, a web service proxy 220, and an adapter 222.

The licensing collection interface 202 and license cache 204 may generate a consolidated license administration view 224. The consolidated license administration view 224 may be one function of a license manager. A license manager may perform many different tasks using data in the license cache 204, including browsing the status of various licenses, monitoring license usage, sending alerts when various conditions exist, and in some cases communicating with a license provider to change license settings.

The adapters 208, 212, and 222 may connect various licensing systems with the licensing collection interface 202, which may be a common interface for a license manager. In some embodiments, the license adapter may connect directly with a license repository or database, such as adapter 212. In other embodiments, the adapter 208 interfaces with the license provider 206 that interfaces with the license repository 204 and the adapter 208 does not connect to the license repository 204 directly. For embodiments where the license repository is located remotely, as in license repository 214, many different components, networks, and applications may be involved on making a connection.

The license repositories 204, 210, and 214 may contain data regarding various licenses. In some embodiments, each license repository may have a unique and specialized structure and function that is specific to the particular software application, component, service, database, or other use. In many cases, such license repositories may be very different. By using an adapter 208, 212, or 222, the data and data formats used by the licensing collection interface 202 may be converted between the specific format for a particular license repository.

In some cases, a license repository 210 may be accessed directly through adapter 212. Such a case may be where a license repository has a database that is reasonably compatible with a data structure used by the licensing collection interface 202. Where the license repository is not compatible, difficult to access, or where some of the data used by the license collection interface 202 is generated on the fly, communication with the license repository may be performed through a license provider 206, as in the case of license repository 204. Such a license provider 206 may be a standalone application that provides data translation and communication functions. In other embodiments, the license provider 206 may be an application programming interface (API) that is exposed from an application or license distribution service.

By using a common data structure or schema for the licensing collection interface 202, licenses from different manufacturers and for different applications or services may be consolidated into a centralized license manager. In many cases, such a system may be used to monitor licenses over many devices or users, such as a home network where several computers and devices are connected as well as large corporate networks having thousands of devices and many more licenses.

A centralized license manager may be a helpful tool for ensuring compliance with licensing agreements, for monitoring efficient usage of computing resources, and for other tasks. The centralized license manager may incorporate licenses managed on a local basis for discrete software installations as well as for services that may be provided over a web-based interface or through the Internet. Even though the various licenses may be provided by different manufacturers or have different terms such as perpetual licenses verses a per-use license, all such licenses may be gathered and managed through a single interface.

In order to manage licenses for services that come through the Internet, an address may be included in the common data structure or schema used by the licensing collection interface. In some cases, the address may be a Uniform Resource Locator (URL) and may also include information that may be used to communicate with a license provider or a license vendor. Such communication may be to initiate a communication session, perform various queries, change parameters for a license, or any other function. In some embodiments, a license manager may be able to store and view license information but may not be able to change the status of a license. A license vendor may be able to perform various functions including purchasing, renewing, or installing licenses.

License information may be stored in the license cache 204 to be used by a license manager. Because license information is stored in the cache 204, information pertaining to a license may be accessed even when a license provider is not available. For example, if a connection to the Internet 218 is down, license information obtained from the license repository 214 may be available through the license cache 204.

The adapters 208, 212, and 222 may be provided by the manufacturers of a license management system or the licensing collection interface 202 may have a schema that is defined in a manner so that third party license providers may create an adapter. The licensing collection interface 202 may use an XML based schema that defines variable data that may be collected by the interface 202.

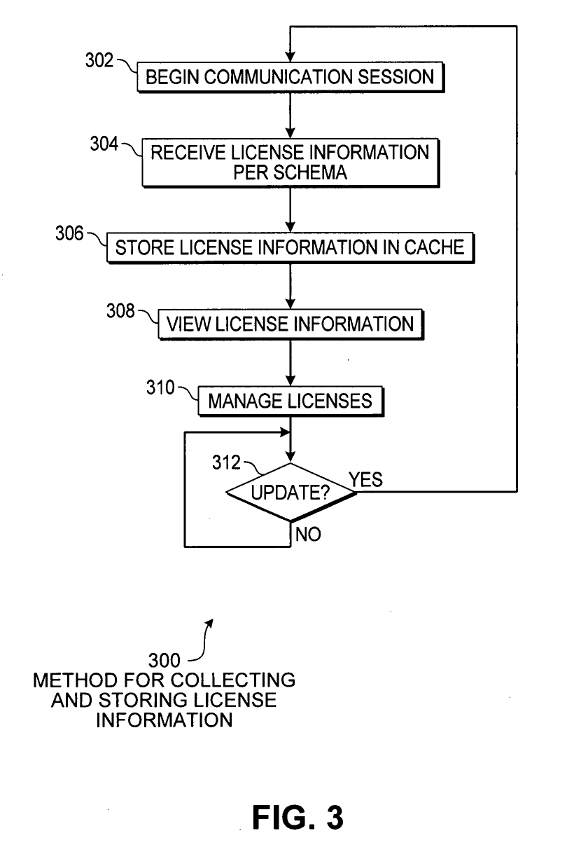

FIG. 3 is a flowchart diagram illustration an embodiment 300 showing a method for collecting and storing license information. A communication session is begun in block 302 and license information is retrieved per a schema in block 304. The license information is stored in a cache in block 306. License information may be viewed in block 308 and the licenses may be further managed in block 310. When another update is to be performed in block 312, the method returns to block 302.

The communication session of block 302 may be initiated by a license manager or by a license provider. In the case of initiation by a license manager, the license manager may send a periodic message to the license provider to gather a current status. The license manager may have a mechanism by which the license manager may discover a licensed software or service and connect to a license provider to pull data.

In other embodiments, a license provider may search for and discover a license manager. The license provider may install an adapter and begin providing data to the license manager by pushing data to the license manager. In some embodiments, the license manager may pull data periodically, and in other embodiments a license provider may push data when a change to a license occurs. In some embodiments, the license manager may perform a query of available license providers when a session is initiated with the license manager. The sequence of query, data update, and the mechanisms by which data are updated may be different for various embodiments and situations.

The license information may include various data about each license, which may include usage data for the license. In some situations, usage data may be collected on a frequent and ongoing basis. Such may be the case for per-use licenses or other dynamic license situations. For perpetual licenses that are installed once, such recurring data collection may be avoided.

Various functions may be performed by a license manager in block 310. In some cases, a license manager may be capable of connecting to a license vendor or may be able to launch a browser with an address for a license vendor so that a user may interact directly with the license provider. When the license manager is able to connect to the license vendor, the license manager may be able to reconfigure licenses, reassign licenses, set permissions or other settings for devices and users on a network, or any other function relating to the licenses. A license vendor may be a system or business through which licenses are procured. In some cases, a license vendor may also perform the task of license provider, which provides data about installed or purchased licenses to a license manager.

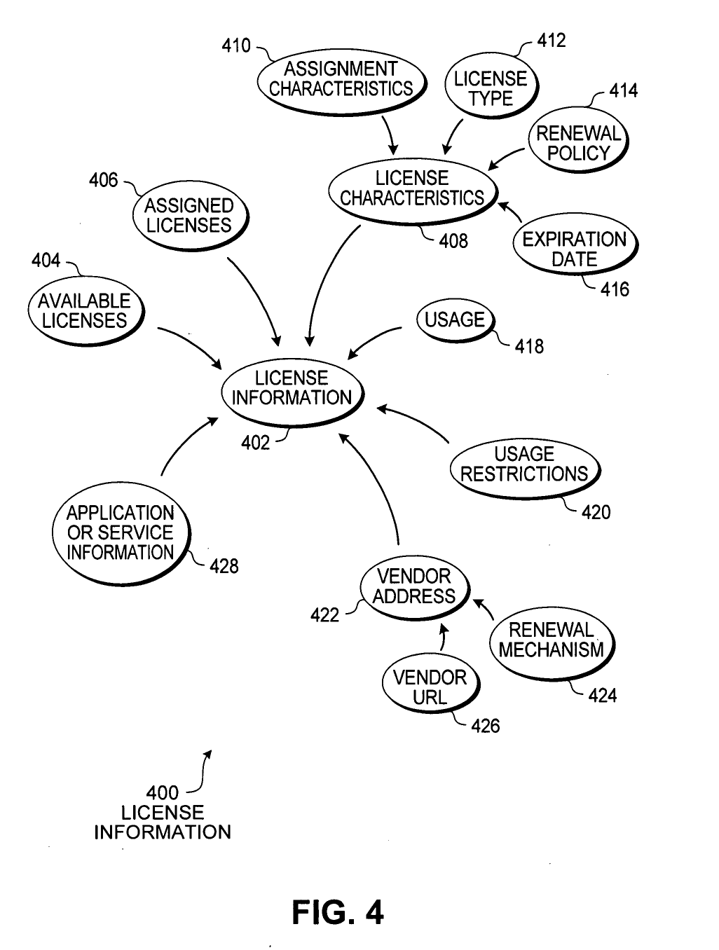

FIG. 4 is a diagram illustration of an embodiment 400 illustrating the components that may make up license information. License information 402 may include available licenses 404 and assigned licenses 406, as well as other data concerning a license.

Available licenses 404 may be the licenses that have been purchased or are tracked by a license manager. The assigned licenses 406 may include those available licenses that have been assigned to specific devices or users. In such an instance, the assigned licenses 406 may be a subset of the available licenses 404. In other instances, the available licenses 404 may be those licenses that have not yet been assigned to a specific device or user and the set of licenses may include the sum of both the available licenses 404 and the assigned licenses 406.

License characteristics 408 may include assignment characteristics 410, a license type 412, a renewal policy 414, and an expiration date 416. The assignment characteristics 410 may include, among other things, descriptors of mechanisms by which a license may be assigned or transferred to a device or user. In some cases, the assignment characteristics 410 may include detailed instructions or steps that may be used by a license manager to communicate with a license provider in order to change the assignment of a license. In other cases, the assignment characteristics may be a data field that describes if a license may be assigned or not. The assignment characteristics 410 may include email addresses for an administrator responsible for the license, an email address for a user to which the license is assigned, and a unique identification for the user.

License type 412 may be a descriptor for a general license type, such as perpetual, transferable, per-user, per-device, on premise, remote service, or any other type of license. Various embodiments may define the license type 412 in different manners.

Renewal policy 414 and expiration date 416 may be variables that are used to define any renewal actions that apply to a license. In cases where a license is perpetual, the expiration date may be set to a default value or a special value such as 0. The renewal policy 414 may include instructions for communicating with a license vendor or license provider to affect a renewal. In other cases, the renewal policy 414 may define some characteristics of a renewal that is performed by a user outside of a license manager. For example, a renewal policy 414 may be an automated monthly renewal using a credit card on file with a license provider. In another example, a renewal policy 414 may indicate that a yearly renewal may be performed through a specific website address for the particular license.

The renewal policy 414 may also include information pertaining to when a license may expire and any grace period associated with the expiration. The renewal policy 414 may further include information about how a license may expire, such as whether a licensed product may partially disable at one point after expiration and become fully disabled after a second point of time.

Usage data 418 may include any type of data pertinent to the usage of a particular license. In some cases, each use of a licensed software or service may be tracked or monitored in some way. Such data may be useful for per-use licenses since a cost may be incurred at each use of the licensed product.

In some cases, usage data may be collected for perpetual licenses. For example, the time periods that a device with a perpetually-licensed operating system is operational may be useful to identify devices on which licensed software have been installed but the devices are not operational. Such devices may have been scrapped, sold, or are in repair and may represent a license cost that is not adding value. In some cases, the unused licenses may be returned or transferred to another device and the purchase of an extra license may be avoided.

Usage restrictions 420 may be part of license information 402 and may define any restrictions for a particular license. For example, some licenses may be used during specific periods of time or operated with specific hardware or software configurations. Other usage restrictions may include a limited number of usages for a licensed product before the product is locked.

Vendor address 422 may be included in license information 402 and may provide a link to communicate with a license provider or license vendor. In some cases, the vendor address 422 may include a renewal mechanism 424 and a vendor URL 426. The renewal mechanism may include addresses, detailed instructions, scripts, or other information that may be used by a license manager or user to perform a renewal of a license. The vendor URL 426 may include a link so that a browser may be used to communicate with the vendor through a website. The vendor URL 426 may include a link to the license provider device and enable a user to modify settings on the license provider device.

The license information 402 may include application or service information 428 that gives information regarding the application or service for which a license exists. The application or service information 428 may include the name of the application or service, characteristics about the application or service, unique identifiers, or other information. Additionally, a license key that is used by the application or service may also be used.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a network connection;
a license collector adapted to receive license information from an application, said license information comprising:
license characteristics;
number of available licenses;
number of assigned licenses;
license expiration date;
an address for a license vendor, said address being a network address; and
a license cache comprising said license information.

2. The system of claim 1 further comprising:
a license administrator adapted to view said license information.

3. The system of claim 1, said license characteristics comprising:
a renewal policy.

4. The system of claim 1, said license characteristics comprising:
a license type.

5. The system of claim 4, said license type being at least one of a group composed of: per device license, per user license, and a per use license.

6. The system of claim 1, said license being for a remote service.

7. The system of claim 6, said remote service being a service provided through the Internet.

8. The system of claim 1, said application being located on a remote device.

9. The system of claim 8, said remote device being located on the Internet.

10. A method comprising:
receiving license information through a license collection interface, said license information comprising:
license characteristics;
number of available licenses;
number of assigned licenses;
license expiration date;
an address for a license vendor, said address being a network address; and
storing said license information in a license cache.

11. The method of claim 10 further comprising:
initiating a communication session with a license provider.

12. The method of claim 10 further comprising:
receiving a communication session initiation from a license provider.

13. The method of claim 10, said license information comprising at least one of a group composed of: usage information and usage restrictions.

14. The method of claim 10, said license information pertaining to a service provided over the Internet.

15. The method of claim 10 further comprising:
connecting to said license vendor using said address.

16. A computer readable medium comprising computer executable instructions adapted to perform the method of claim 10.

17. A computer readable medium having stored thereon a data structure comprising:
a first data field containing available licenses for a software product;
a second data field containing assigned licenses for said software product;
a third data field containing license characteristics for said software product;
a fourth data field containing a license renewal policy for said software product;
a fifth data field containing a network address for a license provider for said software product.

18. The computer readable medium of claim 17, said software product comprising a service provided over a network.

19. The computer readable medium of claim 18, said network being the Internet.

20. The computer readable medium of claim 17, said network address being a Uniform Resource Locator.
